(19) United States
(12) Patent Application Publication
(10) Pub. No.: US 2024/0069925 A1
(43) Pub. Date: Feb. 29, 2024

(54) METHOD FOR CONTROLLING RUNNING OF APPLICATION, AND ELECTRONIC DEVICE

(71) Applicant: GUANGDONG OPPO MOBILE TELECOMMUNICATIONS CORP., LTD., Dongguan (CN)

(72) Inventor: Zifan Huang, Dongguan (CN)

(21) Appl. No.: 18/502,632

(22) Filed: Nov. 6, 2023

Related U.S. Application Data
(63) Continuation of application No. PCT/CN2022/077541, filed on Feb. 24, 2022.

(30) Foreign Application Priority Data
May 11, 2021 (CN) 202110511886.6

(51) Int. Cl. G06F 9/445; G06F 9/50

(52) U.S. Cl. CPC G06F 9/445; G06F 9/5027

(57) ABSTRACT

Provided are a method for controlling running of an application and an electronic device, and the method is implemented by an electronic device. In the method, in response to running of a target application, based on a running condition of the target application program, a control right of a sensor corresponding to the target application is switched to a target operation system matching the running condition. In the target operation system, data output by the sensor is obtained, the data is processed to obtain a corresponding processing result, and the processing result is transmitted to the target application.

### CROSS-REFERENCE OF RELATED APPLICATIONS

The application is a continuation of International Application No. PCT/CN2022/077541 filed Feb. 24, 2022, which claims priority to Chinese Patent Application No. 202110511886.6 filed May 11, 2021. The above-mentioned applications are hereby incorporated by reference in their entireties.

### TECHNICAL FIELD

The present disclosure relates to the field of display technologies, and in particular to a method for controlling running of an application, and an electronic device.

### BACKGROUND

With the development of computer technologies, there are more and more functions and types of mobile terminals, including various personal computers, notebook computers, smart phones, tablet computers, portable wearable devices, and the like. The intelligent service provided by the wearable devices is also more and more diversified, and multiple applications with rich functions can be provided for users to use, for example, a sports and health application that monitors steps and rate, and an electrocardiography (ECG) measurement application may be provided.

However, in the current method for controlling the running of the applications, most of the sports and health algorithms and the sensors are relied on a little core system. Although the little core system offers a long battery life, it has a weak operational capability, and thus it is unable to obtain a balance between the power consumption and performance of the applications.

### SUMMARY

Embodiments of the present disclosure provide a method for controlling running of an application, and an electronic device.

A method for controlling running of an application is provided, which is implemented by an electronic device, and includes:
in response to running of a target application, switching, based on a running condition of the target application, a control right of a sensor corresponding to the target application to a target operating system, the target operating system matching the running condition; and in the target operating system, obtaining data output by the sensor, processing the data to obtain a corresponding processing result, and transmitting the processing result to the target application.

An electronic device is provided, where the computer device includes a memory and one or more processors. The memory stores computer-readable instructions which, when being executed by the one or more processors, cause the one or more processors to:
in response to running of a target application, determine, based on a running condition of the target application, a target operating system matching the running condition; give a control right of a sensor corresponding to the target application to the target operating system; and in the target operating system, obtain data output by the sensor, process the data to obtain a corresponding processing result, and transmit the processing result to the target application.

A method for controlling running of an application is provided, the method is implemented by an electronic device, and includes:
in response to running of a target application, determining, based on a running condition of the target application, a corresponding target operating system matching the running condition; and
calling a sensor hosted by the target operating system, obtaining data output by the sensor, processing the data to obtain a corresponding processing result, and transmitting the processing result to the target application.

The details of one or more embodiments of the present application are set forth in the following drawings and descriptions. Other features and advantages of the present application will be apparent from the description, drawings, and claims.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

In order to more clearly explain technical solutions of the embodiments of the present disclosure, drawings used in the embodiments will be briefly introduced below. Obviously, the drawings as described below are merely some embodiments of the present disclosure. Based on these drawings, other drawings can be obtained by those skilled in the art without inventive effort.

FIG. 1 is a schematic diagram illustrating an application environment in which a method for controlling running of an application is applied according to an embodiment.

FIG. 2 is a flowchart of a method for controlling running of an application according to an embodiment.

FIG. 3 is a flowchart of switching, based on a running condition of a target application, a control right of a sensor corresponding to the target application to a target operating system matching with the running condition, according to an embodiment.

FIG. 4 is a flowchart of a method for controlling running of an application according to another embodiment.

FIG. 5 is a flowchart of a block of determining, based on the running condition of the target application, a corresponding target operating system matching the running condition, according to an embodiment.

FIG. 6 is a flowchart of switching a control right of a sensor to a big core system for processing, according to an embodiment.

FIG. 7 is a flowchart of switching a control right of a sensor to a little core system for processing, according to an embodiment.

FIG. 8 is a structural block diagram of an apparatus for controlling running of an application according to an embodiment.

FIG. 9 is a structural block diagram of an apparatus for controlling running of an application according to another embodiment.

FIG. 10 is an internal structural diagram of an electronic device according to an embodiment.

### DETAILED DESCRIPTION OF PREFERRED EMBODIMENTS

In order to make the technical problems to be solved, technical solutions and beneficial effects of the present disclosure clearer, the present disclosure is further described in detail below with reference to the accompanying drawings and embodiments. It can be understood that the specific embodiments described herein are merely used to explain the present disclosure, and are not intended to limit the present disclosure.

It will be understood that the terms “first”, “second”, and the like used in the present disclosure may be used herein to describe various elements, but these elements are not limited by these terms. These terms are only used to distinguish a first element from another element. For example, without departing from the scope of the present disclosure, a first client may be referred to as a second client, and similarly, the second client may be referred to as the first client. Both the first client and the second client are clients, but they are not a same client.

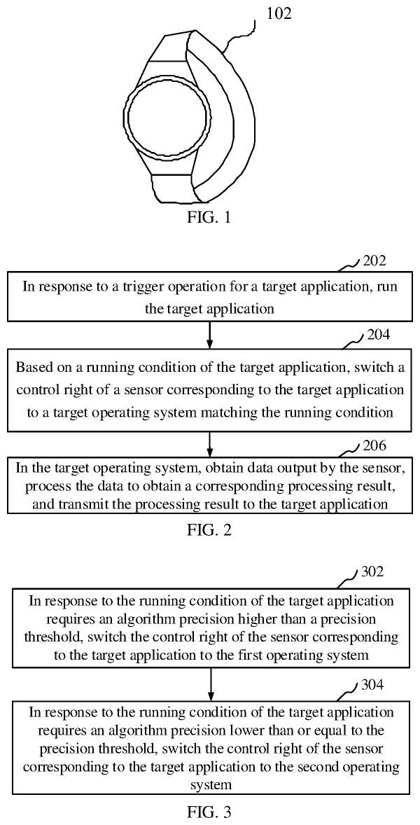

FIG. 1 is a schematic diagram illustrating an application environment in which a method for controlling running of an application is applied, according to an embodiment. As illustrated in FIG. 1, the application environment includes an electronic device 102. The electronic device 102 includes a first processor and a second processor, the first processor runs a first operating system, and the second processor runs a second operating system. The application environment may be an environment in which the user interacts with the electronic device 102. In response to a trigger operation performed by the user for a target application, the electronic device 102 runs the target application. Based on a running condition of the target application, the electronic device 102 switches a control right of a sensor corresponding to the target application to a target operating system matching the running condition. In the target operating system, the electronic device 102 obtains data output by the sensor, processes the data to obtain a corresponding processing result, and transmits the processing result to the target application. The electronic device 102 may be, but is not limited to, various personal computers, notebook computers, smart phones, tablet computers, and portable wearable devices. The portable wearable device may be a smart watch, a smart bracelet, or the like.

FIG. 2 is a flowchart of a method for controlling running of an application according to an embodiment. It is described by taking, as an example, a case where the method for controlling running of an application in the embodiment runs in the electronic device illustrated in FIG. 1. As illustrated in FIG. 2, the method for controlling running of an application includes blocks 202 to 206.

At block 202, in response to a trigger operation for a target application, the target application is run.

The electronic device is an embedded computer system device, and a software structure thereof may be divided into system software and application software. In the software structure of the electronic device, the system software mainly includes an operating system and middleware, and the common operating system for the electronic device includes Apple iOS, Google Android, Hewlett-Packard WebOS, and Microsoft Windows. Users using terminals with different operating system may download various types of applications from an interface of an application market in the electronic device, and the applications may include a system application, a desktop application, a driver application, a network application, a mobile phone application, an Internet of Things application, and the like. The various types of applications may also include instant messaging applications, sports and health applications, audio and video entertainment applications, and the like, in terms of the functions of the applications used by the users. The electronic device in the present disclosure may include a smart phone, a tablet, a wearable device, and the like, and the wearable device may be a smart watch, a smart bracelet, or the like.

Specifically, through a trigger operation, the user may select a certain application in the electronic device, and the application is started, and a display interface of the application is entered. For example, the user may start an ECG measurement application by clicking an icon of the application displayed in a main interface of the electronic device, and an interface of the ECG measurement application is displayed. That is, the user may run various types of applications in the electronic device through a trigger operation, and use functions of the various types of applications. It may be understood that the trigger operation used by the user to start an application includes, but is not limited to, a click operation, a voice operation, a gesture operation or other operations. The trigger manner of the application is not limited, as long as the application can be started. In addition, a sensor is installed in the electronic device, and it may include a sensor having multiple functions, such as a motion sensor, and the electronic device may monitor a corresponding state of the user at the current moment by means of the motion sensor.

It is illustrated by taking the electronic device being a smart bracelet as an example. The smart bracelet may run at least two operating systems, and the at least two operating systems share a same screen. That is, the smart bracelet includes at least two processors, and each processor runs one operating system. It is assumed that the smart bracelet includes a first processor and a second processor, the first processor may be a central processing unit (CPU) or the like, and the second processor may be a microcontroller unit (MCU) or the like. The first processor runs the first operating system, and the second processor runs the second operating system. The power consumption of running the first operating system in the smart bracelet is greater than the power consumption of running the second operating system in the smart bracelet. The at least two operating systems may include an Android operating system, a Linux operating system, a real time operating system (RTOS) operating system, and the like. The Android operating system and the Linux operating system may provide rich functions, and they have strong performance and high power consumption. The RTOS operating system may provide a simple function, but has low power consumption. In response to a trigger operation performed by the user for a target application on the screen of the smart bracelet, the smart bracelet may run the corresponding target application. The target application is an application that is selected by the user from a plurality of applications having different functions and that requires to be used currently. The trigger operation refers to a corresponding trigger event that the user initiates through a series of operations such as a preset gesture, a click operation, and a long press operation. The developer may preset, in a control panel of various applications, functions corresponding to different trigger operations. For example, the operation of single-clicking an application icon may be set to trigger the starting of a corresponding application, and the operation of double-clicking an application icon may be set to trigger the exiting of the current application. The user may start the ECG measurement application by single-clicking the icon of the application, and the smart bracelet runs the ECG measurement application in response to the trigger operation performed by the user for the ECG measurement application.

At block 204, based on a running condition of the target application, a control right of a sensor corresponding to the target application is switched to a target operating system matching the running condition.

After the electronic device runs the target application in response to the trigger operation performed by the user for the corresponding target application, the electronic device may switch, based on the running condition of the target application, the control right of the sensor corresponding to the target application to the target operating system matching the running condition. The running condition refers to a running condition that is correspondingly set based on a running environment of an application in advance. The running condition may include a hardware running condition and a software running condition that are required for the application to run. For example, the running condition may be a running condition related to power consumption, a running condition related to performance. The running condition related to performance may be a high-precision algorithm running condition requiring an algorithm precision higher than a precision threshold, and the running condition related to power consumption may be a low-power-consumption running condition requiring power consumption lower than a power consumption threshold. The electronic device in the present disclosure includes at least two operating systems, i.e., a dual-core dual-system architecture (an MCU system, an Android system), and the running condition of the target application is used to obtain, through a matching operation, an operating system that meets the running condition of the current application from the dual-core dual-system architecture. In addition, the at least two operating systems on the electronic device share the same screen, each processor runs one operating system, and only one processor has the control right of a certain sensor at a same moment. Only the operating system having the control right of the sensor may obtain the data output by the sensor. In order to balance the power consumption and performance of the application, there is a switch in hardware, and the electronic device may switch the sensor to interface with the first operating system or the second operating system. Taking a case where the first operating system is a big core system and the second operating system is a little core system as an example, when the electronic device needs to switch the control right of the sensor to the big core system which matches the running condition of the target application for data processing, the electronic device may operate the switch by means of driving of the big core system, so as to interface the sensor with the big core system. It may be understood that, when the electronic device runs the target application in response to the trigger operation of the user, the little core system having low-power consumption may be set by default to have the control right of the sensor.

Specifically, it is illustrated by taking the electronic device being a smart bracelet as an example. The smart bracelet includes a first processor and a second processor, the first processor runs a first operating system, and the second processor runs a second operating system. The power consumption of running the first operating system in the smart bracelet is greater than the power consumption of running the second operating system in the smart bracelet. After the smart bracelet runs a running app in response to a trigger operation of the user for the target application (the running app), based on a running condition of the running app which is assumed to be a running condition requiring a processing capability of low power consumption, the smart bracelet switches the control right of an embedded sensor corresponding to the running app to the second operating system matching the processing capability of low power consumption. It may be understood that, when there are three or more operating systems running on the electronic device, the power consumption of the individual operating systems may be compared, and the operating systems may be ranked in an order from the highest power consumption to the lowest power consumption or from the lowest power consumption to the highest power consumption; then, a corresponding target operating system is obtained, through the matching operation, based on the power consumption required by the running condition of the running app.

At block 206, in the target operating system, data output by the sensor is obtained, the data is processed to obtain a corresponding processing result, and the processing result is transmitted to the target application.

After the electronic device switches, based on the running condition of the target application, the control right of the sensor corresponding to the target application to the target operating system matching the running condition, in the target operation system, the electronic device obtains the data output by the sensor, processes the data to obtain a corresponding processing result, and transmits the processing result to the target application. The sensor (or transducer) is a detection device capable of sensing measured information, and converting, according to a certain rule, the sensed information into an electrical signal or information in other desired forms for output, so as to meet the requirements of information transmission, processing, storage, display, recording, control and the like. The sensor may include various types of sensors, for example, a gyroscope sensor. The electronic device may have an embedded gyroscope sensor, and acquire corresponding sensed information through the embedded gyroscope sensor. For example, the electronic device detects information such as steps and the rate of the user through the embedded sensor. The processing result is obtained by processing the data output from the sensor, with the matched target operating system that is obtained based on the running condition of the target application.

It is illustrated by taking the electronic device being a smart bracelet as an example. At least two operating systems may simultaneously run on the smart bracelet, and the power consumption of the operating system with multiple functions and strong performance is high at run time. It is assumed that the smart bracelet includes a first processor and a second processor, the first processor runs a first operating system, the second processor runs a second operating system, and the power consumption of running the first operating system in the smart bracelet is greater than the power consumption of running the second operating system in the smart bracelet. It is assumed that the first operating system in the embodiments is an Android operating system (a big core system), and the second operating system is an RTOS operating system (a little core system). After the smart bracelet runs an ECG measurement app in response to a trigger operation of the user for the target application (the ECG measurement app), based on a running condition of the ECG measurement application which is assumed to be a running condition requiring a processing capability of high-precision operation, the smart bracelet switches the control right of an embedded sensor corresponding to the ECG measurement app to the first operating system matching the processing capability of high-precision operation. That is, the smart bracelet switches the control right of the embedded sensor corresponding to the ECG measurement app to the Android operating system matching the processing capability of high-precision operation. In the Android operating system, it performs high-precision operation on the data output by the sensor to obtain a corresponding operation result, and transmits the operation result to the ECG measurement app. The operation result is displayed through the ECG measurement app. The application may set the sampling rate of the sensor. Since the big core system has a strong operational capability, a high sampling rate may be set. The little core system has a weak operational capability; if the sensor data is output at a high frequency, the little core system cannot process such data in time. The big core system has a high operational capability, a large memory and a large code space. Therefore, when the sensor data is output at a high frequency, the big core system may quickly process operations which are more complex.

In the existing method for controlling running of an application, most of the sports and health algorithms and the sensors are relied on the little core system. Although the little core system offers a long battery life, it has a weak operational capability, and thus the data output by the sensor at a high frequency cannot be processed, which limits the algorithm precision of the application. The big core system has a strong operational capability and can process more sensor data, but it renders the battery life to be short. Thus, it is unable to obtain a balance between the power consumption and performance of the application.

In the method for controlling running of an application provided in the embodiment, in response to the trigger operation for the target application, the target application is run; and based on the running condition of the target application, the control right of the sensor corresponding to the target application is switched to the target operating system matching the running condition. In the target operating system, the data output by the sensor is obtained, the data is processed to obtain a corresponding processing result, and the processing result is transmitted to the target application. Therefore, based on the running condition required for an application, an operating system meeting the running condition is determined, through a matching operation, for processing. That is, the control right of the sensor is flexibly switched based on the characteristics of various operating systems, so that the balance between the power consumption and the performance of the application is realized.

In an embodiment, as illustrated in FIG. 3, the target operating system is a first operating system or a second operating system, the power consumption of running the first operating system in the electronic device is greater than the power consumption of running the second operating system in the electronic device, and the operational capability of the electronic device in the first operating system is higher than the operational capability of the electronic device in the second operating system. The switching, based on the running condition of the target application, the control right of the sensor corresponding to the target application to the target operating system matching the running condition, includes operations as follows.

At block 302, in response to the running condition of the target application requiring an algorithm precision higher than a precision threshold, the control right of the sensor corresponding to the target application is switched to the first operating system.

At block 304, in response to the running condition of the target application requiring an algorithm precision lower than or equal to the precision threshold, the control right of the sensor corresponding to the target application is switched to the second operating system.

After the electronic device runs the target application in response to the trigger operation performed by the user for the corresponding target application, based on the running condition of the target application, the electronic device may switch the control right of the sensor corresponding to the target application to the target operating system matching the running condition. Specifically, when the running condition of the target application requires an algorithm precision higher than the precision threshold, the electronic device switches the control right of the sensor corresponding to the target application to the first operating system. When the running condition of the target application requires an algorithm precision lower than or equal to the precision threshold, the electronic device switches the control right of the sensor corresponding to the target application to the second operating system. The target operating system is the first operating system or the second operating system, the power consumption of running the first operating system in the electronic device is greater than the power consumption of running the second operating system in the electronic device, and the operational capability of the electronic device in the first operating system is higher than the operational capability of the electronic device in the second operating system. It may be understood that, in the embodiments, the dual-core dual-system of the electronic device is a hardware architecture based on two processor chips, in which each processor runs an independent operating system, and the two operating systems interact with each other to achieve functions of the hardware devices. In the dual-core dual-system architecture of the electronic device, the first operating system is a big core system, and the second operating system is a little core system. The big core system is a primary processor system in the dual-system architecture, and may generally include an operating system such as an Android operating system and a Linux operating system. The little core system is a secondary processor system in the dual-system architecture, and may generally include an RTOS operating system, a freertos operating system, and the like. The first operating system and the second operating system may communicate via a dual-core communication mechanism. The dual-core communication mechanism is used for data interaction between two operating systems.

It is illustrated by taking the electronic device being a smart bracelet as an example. At least two operating systems can simultaneously run on the smart bracelet, and the power consumption of the operating system with multiple functions and strong performance is usually high at run time. It is assumed that the smart bracelet includes a first processor and a second processor, the first processor runs a first operating system, and the second processor runs a second operating system. That is, in the dual-core dual-system architecture of the smart bracelet, the first operating system is a big core system, the second operating system is a little core system, the power consumption of running the first operating system in the smart bracelet is greater than the power consumption of running the second operating system in the smart bracelet, and the operational capability of the smart bracelet in the first operating system is higher than the operational capability of the smart bracelet in the second operating system.

For example, when the user triggers the starting of a running app by single-clicking an icon of the running app, the smart bracelet runs the running app in response to the trigger operation of the user for the target application (the running app); based on an running condition of the running app which is assumed to be a running condition requiring a processing capability at low power consumption, the smart bracelet switches the control right of the embedded sensor corresponding to the running app to the second operating system (the little core system) matching the processing capability of low power consumption. After obtaining the control right of the sensor, the little core system may obtain data from the sensor through a bus such as an Inter-Integrated Circuit (I2C) bus and a Serial Peripheral Interface (SPI) bus, and perform an operation. When the user triggers the starting of an ECG measurement application by single-clicking an icon of the ECG measurement application, the smart bracelet runs the ECG measurement application in response to the trigger operation performed by the user for the ECG measurement application; and based on an running condition of the ECG measurement application which is assumed to be a running condition requiring a processing capability of high-precision operation, the smart bracelet switches the control right of the embedded sensor corresponding to the ECG measurement application to the first operating system (the big core system) matching the processing capability of high-precision operation. That is, if the app has a high precision requirement on the algorithm, the control right of the sensor may be obtained through an interface for the control right of the sensor that is provided by the big core. For an application scenario where the algorithm precision requirement is not high and there is a low power consumption requirement, both the algorithm and the sensor may be in the little core system. For an application scenario where the algorithm precision requirement is high and there is no specific requirement on the power consumption, both the algorithm and the sensor may be in the big core system. For example, when the ECG measurement is performed, the control right of the sensor may be switched to the big core system, where the big core system has strong operation performance, and it can acquire and process more data of the sensor, which enables the calculation result to be more accurate. For algorithms whose precision requirements are not particularly high, for example, when the steps and rate are detected, the control right of the sensor may be switched to the little core system, where the power consumption of performing the operations at the little core system may be low. Therefore, by flexibly switching the control rights of the sensors, the accuracy of the ECG measurement algorithm can be effectively improved, the user can obtain the health parameter with high precision, and the balance between the power consumption and performance can be obtained.

In an embodiment, the method further includes: making a response to a trigger operation of closing the target application in the first operating system, specifically:
in the first operating system, in response to a trigger operation of closing the target application, the sensor is turned off, and the control right of the sensor is switched from the first operating system to the second operating system.

After the electronic device runs the target application in response to the trigger operation performed by the user for the corresponding target application, based on the running condition of the target application, the electronic device may switch the control right of the sensor corresponding to the target application to the target operating system matching the running condition. Specifically, when the running condition of the target application requires an algorithm precision higher than the precision threshold, the electronic device switches the control right of the sensor corresponding to the target application to the first operating system. In the first operating system, the data output by the sensor is obtained, the data is processed to obtain a corresponding processing result, the processing result is transmitted to the target application, and the operation result is displayed through the target application. Further, after the user views the operation result displayed by the target application, the user may close the target application through a trigger operation. That is, after the user uses the target application, in the first operating system, in response to a trigger operation of closing the target application by the user, the sensor is turned off, and the control right of the sensor is switched from the first operating system to the second operating system. In other words, when an app is exited, the electronic device may automatically switch the control right of the sensor of the app to the little core system through the interface for the control right of the sensor.

For example, when the user triggers the starting of an ECG measurement application by single-clicking an icon of the ECG measurement application, the smart bracelet runs the ECG measurement application in response to the trigger operation performed by the user for the ECG measurement application. Based on the running condition of the ECG measurement application which is assumed to be a running condition requiring a processing capability of high-precision operation, the smart bracelet switches the control right of the embedded sensor corresponding to the ECG measurement application to the first operating system (the big core system) matching the processing capability of high-precision operation. In the first operating system, the data output by the sensor is obtained, the data is processed to obtain a corresponding processing result, the processing result is transmitted to the ECG measurement application, and the operation result is displayed through the ECG measurement application. After the user views the operation result displayed by the ECG measurement application, the user may close the ECG measurement application through a trigger operation. That is, after the user uses the ECG measurement application, in the first operating system, in response to a trigger operation of closing the ECG measurement application that is performed by the user, the sensor is turned off, and the control right of the sensor is switched from the first operating system to the second operating system. The control right of the sensor is switched back to the little core system, because the little core system has low power consumption and the little core system also needs to use the sensor. Due to the low power consumption capability of the little core system, data of the ECG measurement sensor can be obtained and processed within a long period of time, which can met the low power consumption requirement even though it is unable to process the data output at a high frequency.

Since the power consumption of running the first operating system in the smart bracelet is greater than the power consumption of running the second operating system in the smart bracelet, in order to balance the power consumption and the performance of the application, after the user closes the application whose running condition requires the processing capability of high-precision operation, the electronic device switches the control right of the sensor to the operating system with low power consumption (i.e., the second operating system). That is, after the user closes the application whose running condition requires the processing capability of high-precision operation, the control right of the sensor is switched to the operating system with low power consumption. This avoids a problem of high power consumption that is caused by running in an operating system with high power consumption all the time. The power consumption is reduced, and the battery life of the electronic device is prolonged. In this way, the high-precision operation is performed in the big core system, the low-power-consumption operation is performed in the little core system, which enables a balance between high-precision of the algorithm and low power consumption of the system.

In an embodiment, the obtaining the data output by the sensor in the target operating system includes:
in the first operating system, data collected at a first sampling rate and output by the sensor is obtained; and
in the second operating system, data collected at a second sampling rate and output by the sensor is obtained, the second sampling rate being lower than the first sampling rate.

After the electronic device switches, based on the running condition of the target application, the control right of the sensor corresponding to the target application to the target operating system matching the running condition, in the target operating system, the data output by the sensor is obtained and processed to obtain a corresponding processing result, and the processing result is transmitted to the target application. Specifically, in the first operating system, the data collected at the first sampling rate and output by the sensor is obtained. In the second operating system, the data collected at the second sampling rate and output by the sensor is obtained, where the second sampling rate is lower than the first sampling rate. That is, the second operating system (the little core system) has weak operational capability and the first operating system (the big core system) has strong operational capability, when the sensor outputs the data at a high frequency (for example, 200+hz), the little core system is unable to handle the data output by the sensor at the high frequency, which would cause loss of the sensor data and even a stability problem. Due to the fact that the big core system has strong operational capability, more data can be quickly and accurately processed. As such, with the dual-core dual-system (MCU system, Android system) architecture, the processing capability of high-precision operation of the big core system is used, so that the data output by the sensor at the maximum frequency can be obtained and processed, and a more accurate operation result can be obtained.

In an embodiment, the method further includes transmitting the obtained sensor data to the second operating system by the first operating system, including:
while the first operating system has the control right of the sensor, in response to detecting a request for acquiring sensor data that is initiated by the second operating system, the obtained data of the sensor is transmitted to the second operating system by the first operating system.

After the electronic device runs the target application in response to the trigger operation performed by the user for the corresponding target application, based on the running condition of the target application, the electronic device may switch the control right of the sensor corresponding to the target application to the target operating system matching the running condition. Specifically, when the running condition of the target application requires an algorithm precision higher than the precision threshold, the electronic device switches the control right of the sensor corresponding to the target application to the first operating system. In the first operating system, the data output by the sensor is obtained, and the first processor processes the data to obtain a corresponding processing result, and transmits the processing result to the target application. The operation result is displayed through the target application.

Further, while the first operating system has the control right of the sensor, in response to detecting a request for acquiring the sensor data that is initiated by the second operating system, the obtained data of the sensor is transmitted to the second operating system by the first operating system. That is, when the big core system has the control right of the sensor, if the little core system also needs the sensor data at that time, the sensor data may be transmitted to the little core system through a dual-core communication technology. The dual-core communication technology enables reliable data transmission between the big core system and the little core system based on the SPI protocol. The technology of switching the control right of a sensor is to switch the control right of the sensor between the big core system and the little core system based on a dual-core communication technology. Because the dual-core communication mechanism enables data to be stably and quickly transmitted, a data link can be established between the first processor and the second processor, and the first processor and the second processor can send a data packet therebetween through the data link to achieve the purpose of information interaction. Therefore, based on the dual-core communication technology and the technology of switching the control right of a sensor, stable and rapid transmission of the sensor data can be realized, and the running stability of the application is effectively improved.

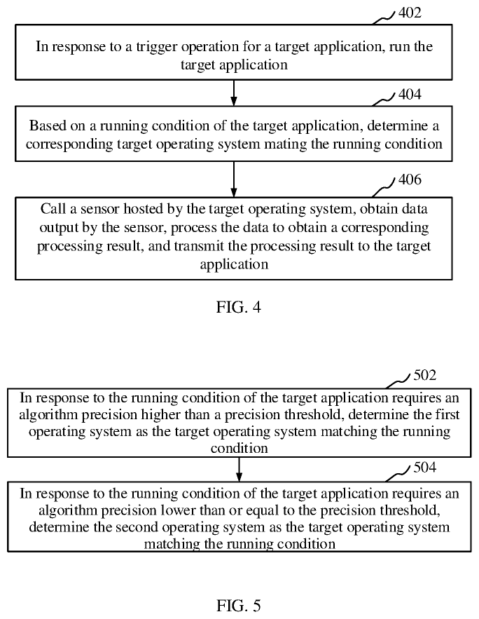

FIG. 4 is a flowchart of a method for controlling running of an application according to another embodiment. It is described by taking, as an example, a case where the method for controlling running of an application in the embodiment is applied to in the electronic device illustrated in FIG. 1. As illustrated in FIG. 4, the method for controlling running of an application includes blocks 402 to 406.

At block 402, in response to a trigger operation for a target application, the target application is run.

At block 404, based on a running condition of the target application, a corresponding target operating system matching the running condition is determined.

At block 406, a sensor hosted by the target operating system is called, data output by the sensor is obtained, the data is processed to obtain a corresponding processing result, and the processing result is transmitted to the target application.

The user selects an application with a specific function in the electronic device through a trigger operation, and the application is started, and a display interface of the application is entered. That is, after the electronic device runs the target application in response to the trigger operation performed by the user for the target application, the electronic device may determine, based on the running condition of the target application, a corresponding target operating system matching the running condition, call a sensor hosted by the target operating system, obtain data output by the sensor, process the data to obtain a corresponding processing result, and transmit the processing result to the target application. The sensor hosted by the target operating system refers to a set of detection devices (sensors) correspondingly configured for the target operating system. The electronic device includes a first processor and a second processor. The second processor may be a processor with low power consumption, and the first processor may be a processor with high power consumption. That is, the second processor is a little core processor and the first processor is a big core processor. It may be understood that, the second processor is the little core processor, and the second operating system implements less functions; however, it is cumbersome to record running contents of an application having a high accuracy requirement on the algorithm, and the recording and processing of the corresponding data burdens the second processor. Thus, the electronic device needs to determine, according to the running condition of the target application, the corresponding target operating system matching the running condition. The first processor runs a first operating system, and the second processor runs a second operating system. Correspondingly, the first operating system can implement more functions than the second operating system. For example, in a state where the first operating system runs, it can detect the body temperature, detect the heart rate, and enable a high resolution of the display page. In a state where the second operating system runs, fewer functions can be implemented, such as a time display function and a watch-face display function. The second processor is, for example, a microcontroller unit (MCU). The first operating system may be an Android operating system (including an operating system deeply developed based on the Android operating system), an IOS operating system (including an operating system deeply developed based on the IOS operating system), or other operating systems. The second operating system may be a real-time operating system (RTOS), a Linux operating system, or other operating systems. In the dual-system architecture of the electronic device, the first operating system is a big core system, the second operating system is a little core system, and each operating system is configured with a corresponding set of sensors.

For example, two sets of sports and health sensors are pre-configured in the electronic device, a set of sports and health sensor A is hosted by the big core system, and a set of sports and health sensor B is hosted by the little core system. When the electronic device determines, based on the running condition (requiring high-precision operation) of the target application (the ECG measurement app), that the corresponding target operating system matching the running condition is the big core system, a sensor A hosted by the big core system is called, that is, the sensor A hosted by the big core system is turned on, the data output by the sensor A at a high frequency is obtained, a high-precision operation is performed on the data output by the sensor to obtain a corresponding operation result, and the operation result is transmitted to the ECG measurement app. The operation result is displayed through the ECG measurement app. After the user views the operation result displayed on the ECG measurement app, the user may close the ECG measurement app through a trigger operation. That is, after the user uses the ECG measurement app, in the big core operating system, the sensor A is closed in response to a trigger operation of closing the ECG measurement app performed by the user. When the electronic device determines, based on the running condition (which requires low power consumption and an algorithm precision lower than or equal to the accuracy threshold) of the target application (the sports and health app), that a corresponding target operating system matching the running condition is the little core system, a sensor B hosted by the little core system is called, that is, the sensor B hosted by the little core system is turned on, the data output by the sensor B at a low frequency is obtained, the data output by the sensor is operated to obtain a corresponding operation result, and the operation result is transmitted to the sports and health app. The operation result is displayed through the sports and health app. After the user views the operation result displayed by the sports and health app, the user may close the sports and health app through a trigger operation. That is, after the user uses the sports and health app, in the little core operating system, the sensor B is closed in response to the trigger operation of closing the sports and health app that is performed by the user. In this way, each of the big core system and the little core system use a set of sensors, there is no need to switch the control right of the sensor, and there is no influence between each other; in addition, it enables the balance between the power consumption and the performance of the application.

In an embodiment, as illustrated in FIG. 5, the target operating system is a first operating system or a second operating system, the power consumption of running the first operating system in the electronic device is greater than the power consumption of running the second operating system in the electronic device, and the operational capability of the electronic device in the first operating system is higher than the operational capability of the electronic device in the second operating system, and the determining, based on the running condition of the target application, the corresponding target operating system matching the running condition includes operations as follow.

At block 502, in response to the running condition of the target application requiring an algorithm precision higher than a precision threshold, the first operating system is determined as the target operating system matching the running condition.

At block 504, in response to the running condition of the target application requires an algorithm precision lower than or equal to the precision threshold, the second operating system is determined as the target operating system matching the running condition.

After the electronic device runs the target application in response to the trigger operation performed by the user for the target application, based on the running condition of the target application, the corresponding target operating system matching the running condition is determined. Specifically, when the running condition of the target application requires an algorithm precision higher than the precision threshold, the electronic device determines the first operating system as the target operating system matching the running condition. When the running condition of the target application requires an algorithm precision lower than or equal to the precision threshold, the electronic device determines the second operating system as the target operating system matching the running condition. The target operating system in the embodiment is the first operating system or the second operating system, the power consumption of running the first operating system in the electronic device is greater than the power consumption of running the second operating system in the electronic device, and the operational capability of the electronic device in the first operating system is higher than the operational capability of the electronic device in the second operating system. When the electronic device detects that the running condition of the target application requires an algorithm precision higher than the precision threshold, the first operating system is determined as the target operating system matching the running condition. The first operating system has strong operational capability, a large memory and a large code space, so that a large amount of operations, complex operations and fast operations can be performed. The first operating system can provide rich functions and has high performance, but it is high in power consumption. When the electronic device detects that the running condition of the target application requires an algorithm precision lower than or equal to the precision threshold, the second operating system is determined as the target operating system matching the running condition. The second operating system has weak operational capability and low power consumption, that is, it can provide simple functions but reduce the power consumption. In this way, since it determines, based on the running condition required by an application, a matching operating system meeting the running condition for processing, that is, according to the characteristics of different operating systems, the high-precision operation is performed in the big core system and the low-power-consumption operation is performed in the little core system, it enables the balance of the high precision of algorithm and the low power consumption of system.

In an embodiment, it is illustrated by taking the electronic device being a smart bracelet as an example. The smart bracelet is internally provided with a sensor. The smart bracelet in the embodiment includes at least two operating systems, that is, it is in a dual-core dual-system architecture. Assuming that the smart bracelet includes a first processor and a second processor, the first processor runs an Android operating system, and the second processor runs a RTOS operating system. The power consumption of running the Android operating system in the smart bracelet is greater than the power consumption of running the RTOS operating system in the smart bracelet, and the operational capability of the smart bracelet in the Android operating system is higher than the operational capability of the smart bracelet in the RTOS operating system.

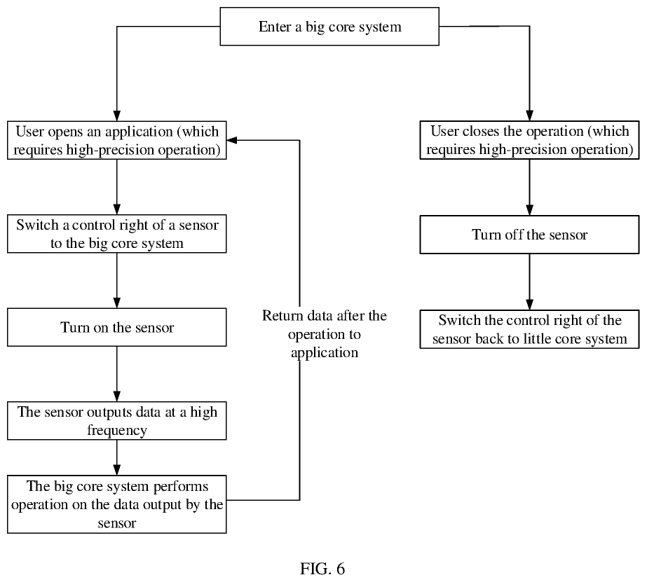

As illustrated in FIG. 6, a flowchart of switching a control right of a sensor to a big core system for processing is shown. The user turns on the wearable device, i.e., the smart bracelet, and the Android system is entered. The user triggers the starting of an ECG measurement application by single-clicking an icon of the ECG measurement application, that is, the smart bracelet runs the ECG measurement application in response to the trigger operation of the user for the ECG measurement application. Assuming that the running condition of the ECG measurement application requires a processing capability of high-precision operation, the smart bracelet may switch, based on the running condition of the ECG measurement application, a control right of the embedded sensor corresponding to the ECG measurement application to the Android operating system (the big core system) matching the processing capability of high-precision operation. In the Android operating system, the sensor is started, the data output by the sensor at a high frequency is obtained, a high-precision operation is performed on the data output by the sensor to obtain a corresponding operation result, and the operation result is transmitted to the ECG measurement application. The operation result is displayed through the ECG measurement application. After the user views the operation result displayed by the ECG measurement application, the user may close the ECG measurement application through a trigger operation. That is, after the user uses the ECG measurement application, in the Android operating system, in response to a trigger operation of closing the ECG measurement application by the user, the sensor is turned off, and the control right of the sensor is switched from the Android operating system to the RTOS operating system. That is, after the user closes an application whose running condition requires a processing capability of high-precision operation, the electronic device switches the control right of the sensor to the operating system with low power consumption (that is, the RTOS operating system), thereby achieving a balance between the power consumption and the performance of the application.

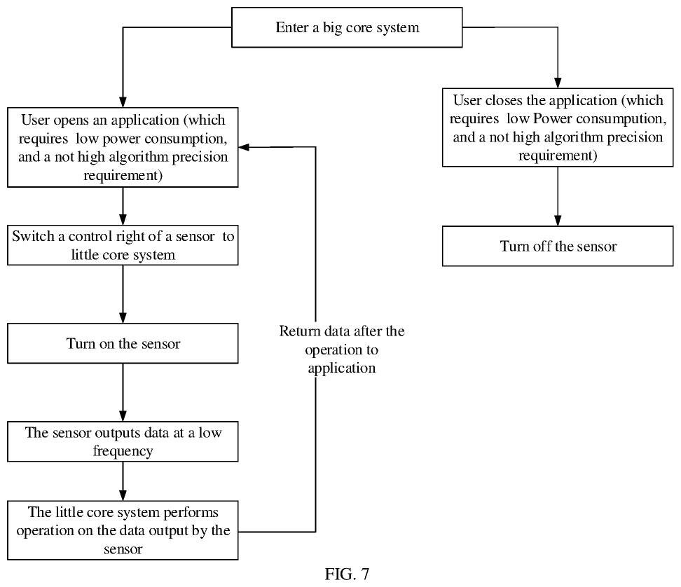

As illustrated in FIG. 7, a flowchart of switching a control right of a sensor to a little core system for processing is shown. The user turns on the wearable device, i.e., the smart bracelet, and the Android system is entered. The user triggers the starting of a running application by single-clicking an icon of the running application, and the smart bracelet runs the running app in response to the trigger operation of the user for the target application (the running app). Assuming that the running condition of the running app requires a processing capability having low power consumption and a not high algorithm requirement, the smart bracelet may switch, based on the running condition of the running app, the control right of the embedded sensor corresponding to the running app to the RTOS operating system (the little core system) matching the processing capability of low power consumption. In the RTOS operating system, the sensor is started, the data output by the sensor at a low frequency is obtained, the data output by the sensor is operated to obtain a corresponding operation result, and the operation result is transmitted to the running app. The operation result is displayed through the running app. After the user views the operation result displayed by the running app, the user may close the running app through a trigger operation. That is, after the user uses the running app, in the RTOS operating system, in response to a trigger operation of closing the running app by the user, the sensor is closed. Since the running condition of the running app may be met in the RTOS operating system of low power consumption, there is no need to switch the control right of the sensor when the smart bracelet runs in the RTOS operating system of low power consumption by default, to meet the balance between the power consumption and the performance of the application.

It may be understood that, although the operations in the flowcharts of FIG. 1 to FIG. 7 are shown in sequence according to the indication of the arrows, the operations are not necessarily performed sequentially in the order indicated by the arrows. Unless explicitly stated herein, these operations are not limited to be performed strictly in a certain order, which may be performed in other orders. Moreover, at least some of the operations in FIG. 1 to FIG. 7 may include multiple sub-operations or multiple stages, and these sub-operations or stages are not necessarily performed at the same time, but may be performed at different moments, and these sub-operations or stages are not necessarily performed sequentially, but may be performed in turn or alternatively with at least a part of the sub-operations or stages of other operations or other operations.

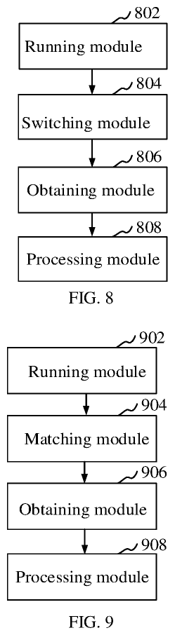

FIG. 8 is a structural block diagram of an apparatus for controlling running of an application according to an embodiment. As illustrated in FIG. 8, an apparatus for controlling running of an application is provided, and the apparatus includes a running module 802, a switching module 804, an obtaining module 806, and a processing module 808.

The running module 802 is configured to run a target application in response to a trigger operation for the target application.

The switching module 804 is configured to switch, based on a running condition of the target application, a control right of a sensor corresponding to the target application to a target operating system matching the running condition.

The obtaining module 806 is configured to obtain, in the target operating system, data output by the sensor.

The processing module 808 is configured to process the data to obtain a corresponding processing result, and transmit the processing result to the target application.

In an embodiment, the switching module is further configured to: switch the control right of the sensor corresponding to the target application to a first operating system, when the running condition of the target application requires an algorithm precision higher than a precision threshold; and switch the control right of the sensor corresponding to the target application to a second operating system, when the running condition of the target application requires an algorithm precision lower than or equal to the precision threshold.

In an embodiment, the switching module is further configured to: in the first operating system, in response to a trigger operation of closing the target application, close the sensor and switch the control right of the sensor from the first operating system to the second operating system.

In an embodiment, the obtaining module is further configured to: obtain, in the first operating system, data collected at a first sampling rate and output by the sensor; and obtain, in the second operating system, data collected at a second sampling rate and output by the sensor, where the second sampling rate is lower than the first sampling rate.

In an embodiment, the apparatus further includes a detection module.

The detection module is configured to: transmit the obtained data of the sensor to the second operating system by the first operating system, in response to detecting a request for acquiring sensor data that is initiated by the second operating system, while the first operating system has the control right of the sensor.

FIG. 9 is a structural block diagram of an apparatus for controlling running of an application according to another embodiment. As illustrated in FIG. 9, an apparatus for controlling running of an application is provided, and the apparatus includes a running module 902, a matching module 904, an obtaining module 906, and a processing module 908.

The running module 902 is configured to run a target application in response to a trigger operation for the target application.

The matching module 904 is configured to determine, based on a running condition of the target application, a corresponding target operating system matching the running condition.

The obtaining module 906 is configured to call a sensor hosted by the target operating system, and obtain data output by the sensor.

The processing module 908 is configured to process the data to obtain a corresponding processing result, and transmit the processing result to the target application.

In an embodiment, the matching module is further configured to: determine a first operating system as the target operating system matching the running condition, when the running condition of the target application requires an algorithm precision higher than a precision threshold; and determine a second operating system as the target operating system matching the running condition, when the running condition of the target application requires an algorithm precision lower than or equal to the precision threshold.

The division of various modules in the apparatus for controlling running of an application is merely used for illustration, and in other embodiments, the apparatus for controlling running of an application may be divided into different modules as required to implement all or some functions of the apparatus for controlling running of an application.

For a specific limitation of the apparatus for controlling running of an application, reference may be made to the definitions of the method for controlling running of an application, and details are not described herein again. Each module in the apparatus for controlling running of an application may be implemented in whole or in part by software, hardware, or a combination thereof. The foregoing modules may be embedded in or independent of the processor in the computer device in a hardware form, or may be stored in a memory in the computer device in a software form, so that the processor calls the operations corresponding to the foregoing modules.

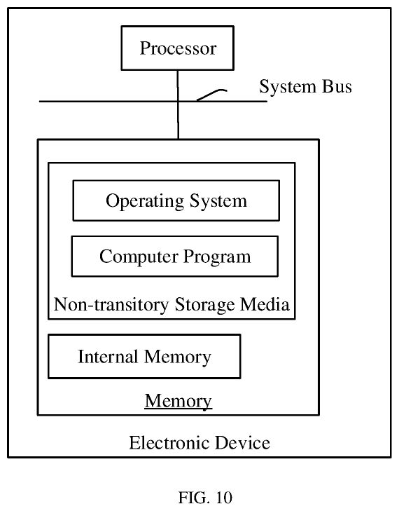

FIG. 10 is schematic diagram illustrating an internal structural of an electronic device according to an embodiment. As illustrated in FIG. 10, the electronic device includes a processor and a memory connected by a system bus. The processor is configured to provide calculation and control capabilities to support operations of the entire electronic device. The memory may include a non-volatile storage medium and an internal memory. The non-volatile storage medium stores an operating system and computer-readable instructions. The computer readable instructions may be executed by the processor to implement the method for controlling running of an application provided by the foregoing embodiments. The internal memory provides an operating environment of a cache for computer readable instructions of the operating system in the non-volatile storage medium. The electronic device may be any terminal device such as a mobile phone, a tablet computer, a Personal Digital Assistant (PDA), a Point of Sales (POS), a vehicle-mounted computer, a wearable device, or the like.

The various modules in the apparatus for controlling running of an application provided in the embodiment of the present disclosure may be implemented in a form of computer-readable instructions. The computer-readable instructions may run on a terminal or a server. Program modules constituted by the computer-readable instructions may be stored on a memory of the electronic device. When the computer-readable instructions are executed by the processor, the operations of the method described in the embodiments of the present disclosure are implemented.

A computer device is provided, which includes a memory and one or more processors. The memory stores computer-readable instructions. The computer-readable instructions are stored in one or more non-transitory storage media. When the computer-readable instructions are executed by the one or more processors, the one or more processors are caused to implement the operations of the method for controlling running of an application provided in any one embodiment of the present disclosure.

The embodiments of the present disclosure further provide a computer-readable storage medium, such as one or more non-transitory computer-readable storage media including computer-executable instructions. When the computer-executable instructions are executed by one or more processors, the one or more processors are caused to perform operations of the method for controlling running of an application.

A computer-readable instruction product is provided, which includes instructions thereon. When the instructions are executed on a computer, the computer is caused to execute the method for controlling running of an application.

Any reference to a memory, storage, database, or other medium used in the present disclosure may include non-volatile and/or volatile memory. The non-volatile memory may include read-only memory (ROM), programmable ROM (PROM), electrically programmable ROM (EPROM), electrically erasable programmable ROM (EEPROM), or flash memory. Volatile memory may include random access memory (RAM), which serves as an external cache. By way of illustration and not limitation, RAM is available in a variety of forms, such as static RAM (SRAM), dynamic RAM (DRAM), synchronous DRAM (SDRAM), double data rate SDRAM (DDR SDRAM), enhanced SDRAM (ESDRAM), synchlink DRAM (SLDRAM), Rambus direct RAM (RDRAM), direct Rambus dynamic RAM (DRDRAM), and Rambus dynamic RAM (RDRAM).

The foregoing embodiments only illustrate several implementations of the present disclosure, and their descriptions are relatively specific and detailed, but they cannot be construed as limiting the scope of the present disclosure. It is notable for those skilled in the art that, several variations and modifications may be made by those skilled in the art without departing from the concept of the present disclosure, and all of them should fall within the protection scope of the present disclosure. Accordingly, the protection scope of the present disclosure is subject to the appended claims.

What is claimed is:

1. A method for controlling running of an application, implemented by an electronic device, the method comprising:
in response to running of a target application, switching, based on a running condition of the target application, a control right of a sensor corresponding to the target application to a target operating system, the target operating system matching the running condition; and
in the target operating system, obtaining data output by the sensor, processing the data to obtain a corresponding processing result, and transmitting the processing result to the target application.

2. The method of claim 1, wherein the target operating system is a first operating system or a second operating system, power consumption of running the first operating system in the electronic device is greater than power consumption of running the second operating system in the electronic device, and an operational capability of the electronic device in the first operating system is higher than an operational capability of the electronic device in the second operating system; and switching, based on the running condition of the target application, the control right of the sensor corresponding to the target application to the target operating system matching the running condition comprises:
in response to the running condition of the target application requiring an algorithm precision higher than a precision threshold, switching the control right of the sensor corresponding to the target application to the first operating system; and
in response to the running condition of the target application requiring an algorithm precision lower than or equal to the precision threshold, switching the control right of the sensor corresponding to the target application to the second operating system.

3. The method of claim 2, further comprising:
in the first operating system, in response to a trigger operation of closing the target application, turning off the sensor, and switching the control right of the sensor from the first operating system to the second operating system.

4. The method of claim 2, wherein obtaining the data output by the sensor in the target operating system comprises:
obtaining, in the first operating system, data collected at a first sampling rate and output by the sensor; or
obtaining, in the second operating system, data collected at a second sampling rate and output by the sensor, wherein the second sampling rate is lower than the first sampling rate.

5. The method of claim 2, further comprising:
while the first operating system has the control right of the sensor, in response to detecting a request of acquiring sensor data that is initiated by the second operating system, transmitting the obtained data of the sensor to the second operating system by the first operating system.

6. The method of claim 1, further comprising:
in response to a trigger operation for the target application, running the target application.

7. The method of claim 1, wherein the electronic device comprises at least two operating systems, and only one operating system has the control right of the sensor at one moment, and the method further comprises:
determining, based on the running condition of the target application, the target operating system from the at least two operating systems.

8. The method of claim 2, wherein the first operating system is an Android operating system or a Linux operating system, and the second operating system is a real time operating system.

9. The method of claim 1, wherein the running condition comprises a running condition related to power consumption and a running condition related to performance, the running condition related to power consumption is a low-power-consumption running condition requiring power consumption lower than a power consumption threshold, and the running condition related to performance is a high-precision algorithm running condition requiring an algorithm precision higher than a precision threshold.

10. The method of claim 2, wherein the electronic device has a switch in hardware, and switching the control right of the sensor corresponding to the target application to the target operating system comprises:
switching, through the switch, the sensor corresponding to the target application to interface with the first operating system or the second operating system.

11. The method of claim 1, wherein when the running condition requires a processing capability of low power consumption, and there are multiple operating systems running on the electronic device, the method further comprises:
comparing power consumption of the individual operating systems;
ranking the operating systems in an order from highest power consumption to lowest power consumption or from the lowest power consumption to the highest power consumption; and
obtaining the target operating system, through a matching operation, based on the power consumption required by the running condition of the target application.

12. A method for controlling running of an application, implemented by an electronic device, the method comprising:
in response to running of a target application, determining, based on a running condition of the target application, a target operating system matching the running condition; and
calling a sensor hosted by the target operating system, obtaining data output by the sensor, processing the data to obtain a corresponding processing result, and transmitting the processing result to the target application.

13. The method of claim 12, wherein the target operating system is a first operating system or a second operating system, power consumption of running the first operating system in the electronic device is greater than power consumption of running the second operating system in the electronic device, and an operational capability of the electronic device in the first operating system is higher than an operational capability of the electronic device in the second operating system, and determining, based on the running condition of the target application, the corresponding target operating system matching the running condition comprises:
in response to the running condition of the target application requiring an algorithm precision higher than a precision threshold, determining the first operating system as the target operating system matching the running condition; and
in response to the running condition of the target application requiring an algorithm precision lower than or equal to the precision threshold, determining the second operating system as the target operating system matching the running condition.

14. The method of claim 12, wherein the sensor hosted by the target operating system refers to a set of detection devices correspondingly configured for the target operating system.

15. An electronic device, comprising a memory and one or more processors, wherein the memory stores computer-readable instructions which, when being executed by the one or more processors, cause the one or more processors to:
in response to running of a target application, determine, based on a running condition of the target application, a target operating system matching the running condition;
give a control right of a sensor corresponding to the target application to the target operating system; and
in the target operating system, obtain data output by the sensor, process the data to obtain a processing result, and transmit the processing result to the target application.

16. The electronic device of claim 15, wherein the electronic device has a switch in hardware, and the computer-readable instructions, when being executed by the one or more processors, further cause the one or more processors to:
switch, through the switch, the sensor corresponding to the target application to interface with the target operating system.

17. The electronic device of claim 16, wherein the target operating system is a first operating system or a second operating system, power consumption of running the first operating system in the electronic device is greater than power consumption of running the second operating system in the electronic device, and an operational capability of the electronic device in the first operating system is higher than an operational capability of the electronic device in the second operating system, and the computer-readable instructions, when being executed by the one or more processors, further cause the one or more processors to:
in response to the running condition of the target application requiring an algorithm precision higher than a precision threshold, determine the first operating system as the target operating system matching the running condition; and
in response to the running condition of the target application requiring an algorithm precision lower than or equal to the precision threshold, determine the second operating system as the target operating system matching the running condition.

18. The electronic device of claim 17, wherein the computer-readable instructions, when being executed by the one or more processors, further cause the one or more processors to:
in the first operating system, in response to a trigger operation of closing the target application, turn off the sensor, and switch the control right of the sensor from the first operating system to the second operating system.

19. The electronic device of claim 17, wherein the computer-readable instructions, when being executed by the one or more processors, further cause the one or more processors to:
obtain, in the first operating system, data collected at a first sampling rate and output by the sensor; or
obtain, in the second operating system, data collected at a second sampling rate and output by the sensor, wherein the second sampling rate is lower than the first sampling rate.

20. The electronic device of claim 17, wherein the computer-readable instructions, when being executed by the one or more processors, further cause the one or more processors to:
while the first operating system has the control right of the sensor, in response to detecting a request of acquiring sensor data that is initiated by the second operating system, transmit the obtained data of the sensor to the second operating system by the first operating system.
